(19) United States
(12) Patent Application Publication
(10) Pub. No.: US 2026/0099263 A1
(43) Pub. Date: Apr. 9, 2026

(54) STORAGE DEVICE AND OPERATING METHOD OF THE SAME

(71) Applicant: Samsung Electronics Co., Ltd., Suwon-si (KR)

(72) Inventors: Dae-kyu PARK, Suwon-si (KR); Seunghwan HA, Suwon-si (KR)

(73) Assignee: Samsung Electronics Co., Ltd., Suwon-si (KR)

(21) Appl. No.: 19/349,576

(22) Filed: Oct. 3, 2025

(30) Foreign Application Priority Data
Oct. 7, 2024 (KR) 10-2024-0135951

(51) Int. Cl. G06F 3/06

(52) U.S. Cl. CPC G06F 3/0638; G06F 3/0608; G06F 3/0679

(57) ABSTRACT

Disclosed is a storage device which includes a memory device including a plurality of nonvolatile memory blocks, and a memory controller configured to control the memory device. The memory controller is configured to determine continuity of a first physical address of first user data among user data stored in the memory device in a read operation unit of the memory device in response to a sequential read command for the user data, and store the first user data whose first physical address is discontinuous at a second physical address continuous in the read operation unit of the memory device.

### CROSS-REFERENCE TO RELATED APPLICATIONS

This application claims priority under 35 U.S. C. § 119 to Korean Patent Application No. 10-2024-0135951 filed on Oct. 7, 2024, in the Korean Intellectual Property Office, the disclosures of which are incorporated by reference herein in their entireties.

### BACKGROUND

Example embodiments of the present disclosure described herein relate to storage devices and operating methods thereof, and more particularly, relate storage devices defragmenting user data in a read operation unit of a memory device and operating methods thereof.

The amount of data is increasing as artificial intelligence (AI) and autonomous driving are commercialized. In this case, a storage capacity of a data center may also continuously increase, and services of the data center are also evolving. As the flash memory-based solid state drive (SSD) offers high input/output (I/O) performance and low energy consumption compared to a hard disk drive (HDD), the use of the solid state drive is expanding in a data center and cloud computing environment where multiple users share resources.

A storage device which is based on a flash memory device may perform various operations to maintain performance. For example, the storage device may defragment user data stored in a memory device.

### SUMMARY

Example embodiments of the present disclosure provide storage devices capable of improving the quality of service and operating methods thereof.

Example embodiments of the present disclosure provide storage devices performing efficient defragmentation in a flash memory-based storage device and operating methods thereof.

According to some example embodiments, a storage device may include a memory device including a plurality of nonvolatile memory blocks, and a memory controller configured to control the memory device. The memory controller may be configured to determine continuity of a first physical address of first user data among user data stored in the memory device in a read operation unit of the memory device in response to a sequential read command for the user data, and may be configured to store the first user data whose first physical address is discontinuous at a second physical address continuous in the read operation unit of the memory device.

According to some example embodiments, a storage device may include a memory device including a plurality of nonvolatile memory blocks, and a memory controller configured to control the memory device. The memory controller may be configured to receive a write command including a first logical address and first user data, may be configured to determine continuity of a second logical address of second user data and continuity of a second physical address of the second user data in a read operation unit of the memory device, and may be configured to store pieces of user data other than user data stored at a first physical address from among pieces of second user data stored at the second physical address and the first user data as a third physical address as third data, based on the second logical address and the second physical address being continuous. The third physical address may be continuous in the read operation unit of the memory device, the first logical address may be included in the second logical address, and the first logical address may be mapped to the first physical address.

According to some example embodiments, an operating method of a storage device may include receiving, at a memory controller, a sequential read command for user data, determining, at the memory controller, continuity of a first physical address of first user data among the user data stored in a memory device in a read operation unit of the memory device, and storing, at the memory controller, the first user data, the first physical address of which is discontinuous, at a second physical address continuous in the read operation unit of the memory device.

According to some example embodiments, a storage system may include a host device and a storage device which may include a memory device including a plurality of nonvolatile memory blocks, and a memory controller configured to control the memory device. The memory controller may be configured to determine continuity of a first physical address of first user data among user data stored in the memory device in a read operation unit of the memory device in response to a sequential read command for the user data, and may be configured to store the first user data whose first physical address is discontinuous at a second physical address continuous in the read operation unit of the memory device. In some example embodiments, the host may be configured to control the memory device, and instruct the memory device to enter an idle state.

### BRIEF DESCRIPTION OF THE FIGURES

The above and other objects and features of the present disclosure will become apparent by describing in detail embodiments thereof with reference to the accompanying drawings.

FIG. 1 is a block diagram describing a storage device according to some example embodiments of the present disclosure.

FIG. 2 is a diagram describing a method of determining fragmentation, according to some example embodiments of the present disclosure.

FIG. 3 is a diagram illustrating a software architecture of a storage device of FIG. 1.

FIG. 4 is a diagram describing a configuration of a storage device according to some example embodiments of the present disclosure.

FIG. 5 is a diagram describing a configuration of a memory controller according to some example embodiments of the present disclosure.

FIG. 6 is a diagram describing a configuration of a memory device according to some example embodiments of the present disclosure.

FIG. 7 is a diagram illustrating a configuration according to some example embodiments of a memory block according to some example embodiments of the present disclosure.

FIG. 8 is a diagram describing a configuration according to some example embodiments of a defragmenter.

FIG. 9 is a diagram describing user data with continuity according to some example embodiments of the present disclosure.

FIG. 10 is a diagram describing user data with discontinuity according to some example embodiments of the present disclosure.

FIG. 11 is a diagram describing defragmentation of user data with discontinuity according to some example embodiments of the present disclosure.

FIG. 12 is a diagram describing an input/output manager according to some example embodiments of the present disclosure.

FIG. 13 is a diagram describing a configuration according to some example embodiments of a defragmenter.

FIG. 14 is a diagram describing a defragmentation list according to some example embodiments of the present disclosure.

FIG. 15 is a diagram describing a configuration according to some example embodiments of a defragmenter.

FIG. 16 is a diagram describing user data before a defragmenter according to some example embodiments performs defragmentation.

FIG. 17 is a diagram describing user data after a defragmenter according to an alternative embodiment performs defragmentation.

FIG. 18 is a diagram describing user data after a defragmenter according to some example embodiments performs defragmentation.

FIGS. 19 to 21 are flowcharts describing an operating method of a storage device according to embodiments of the present disclosure.

FIG. 22 is a block diagram showing a storage system according to some example embodiments.

### DETAILED DESCRIPTION

Below, embodiments of the present disclosure will be described in detail and clearly to such an extent that an ordinary one in the art easily carries out the present disclosure.

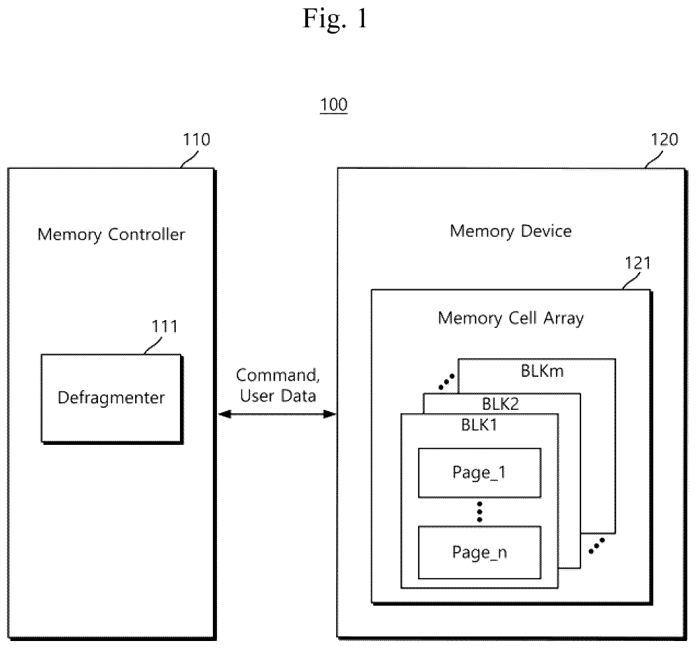

FIG. 1 is a block diagram illustrating a storage device 100 according to some example embodiments of the present disclosure. The storage device 100 according to some example embodiments of the present disclosure will be described with reference to FIG. 1.

The storage device 100 according to some example embodiments of the present disclosure may include a defragmenter 111 which uses defragmentation of user data. The defragmenter 111 may determine fragmentation of the user data. The defragmenter 111 may determine the fragmentation of the user data in a read operation unit of a memory device 120. The defragmenter 111 may perform the defragmentation of the user data fragmented in the read operation unit of a memory device 120.

The description will be given in detail with reference to FIG. 1. Referring to FIG. 1, the storage device 100 may include a memory controller 110 and the memory device 120.

The storage device 100 may be an internal memory embedded in an electronic device. For example, the storage device 100 may include a solid state drive (SSD), an embedded universal flash storage (UFS) device, or an embedded multi-media card (eMMC).

Alternatively, the storage device 100 may be an external storage device removable from an electronic device. For example, the storage device 100 may include a UFS memory card, a compact flash (CF) card, a secure digital (SD) card, a micro-SD card, a mini-SD card, an extreme digital (xD) card, or a memory stick.

However, this is provided as an example. According to some example embodiments, the storage device 100 may be referred to as a “personal computer”, a “data server”, “network attached storage” (NAS), an “Internet of Things (IoT) device”, a “portable electronic device”, etc.

The storage device 100 may be electrically connected to a host so as to be used by the host, and the storage device 100 is capable of being accessed through a direct media access (DMA) of any other device in addition to the host.

The storage device 100 may be implemented in a state of being physically separated from the host or may be implemented with the form factor mounted on the same package as the host. For example, the storage device 100 may be implemented based on the E1.S, E1.L, E3.S, E3.L, or PCIe AIC (CEM) form factor. Alternatively, the storage device 100 may be implemented based on the U.2 form factor, the M.2 form factor, or any other PCIe form factor.

The storage device 100 may be coupled such that the communication with any other components of the host through a storage interface bus is possible. According to some example embodiments, the storage device 100 may be directly mounted on a physical port which is based on the peripheral component interconnect express (PCIe) of the host. The storage interface bus may be, for example, a PCIe bus. The host may exchange data with the storage device 100 through the storage interface bus by using a storage interface protocol. The data may include user data. The storage interface protocol may be, for example, a compute express link (CXL) protocol and/or a non-volatile memory host controller express (NVMe) protocol.

The memory controller 110 may control the memory device 120 to perform a request received from the host. The request of the host may include a request for a write operation, a read operation, and/or an erase operation of user data. The write operation may be referred to as a “record operation, a “store operation”, and/or a “program operation”. In the specification, the expression “the memory controller 110 performs the write operation of data” is used as the same meaning as the memory controller 110 controls the memory device 120 such that data are programmed in the memory device 120. The data may be user data or may be any other preset (or, alternatively, desired or determined) pattern data.

The memory device 120 may include a flash memory of a two-dimensional (2D) structure or a two-dimensional (3D) structure. The flash memory may include different kinds of nonvolatile memories such as a NAND flash memory, a vertical NAND (V-NAND) flash memory, a NOR flash memory, a magnetic RAM (MRAM), a phase-change RAM (PRAM), a ferroelectric random access memory (FRAM), a spin transfer torque random access memory (STT-RAM), and/or a resistive RAM (RRAM).

The memory controller 110 may control the memory device 120 depending on a request of an external device (e.g., a host). For example, to read the user data depending on the request of the host, the memory controller 110 may transmit an address and a command to the memory device 120. The memory controller 110 may exchange data with the memory device 120 depending on the request of the external device such as a host.

The memory device 120 may include a memory cell array 121, and the memory cell array 121 may include a plurality of memory blocks BLK1 to BLKm. In the specification, a memory block may be simply marked by a block. Each of the plurality of blocks BLK1 to BLKm may include a plurality of memory cells. Each of the plurality of memory cells may be a single level cell (SLC) storing 1-bit data or may be a multi-level cell (MLC) storing 2-bit data. Alternatively, each of the plurality of memory cells may be a triple level cell (TLC) storing 3-bit data may be a quadruple level cell (QLC) storing 4-bit data. In the specification, the size of data stored in a memory cell may not be specifically limited, and a memory cell may store various sizes of bit data.

The storage device 100 according to some example embodiments of the present disclosure may include the defragmenter 111.

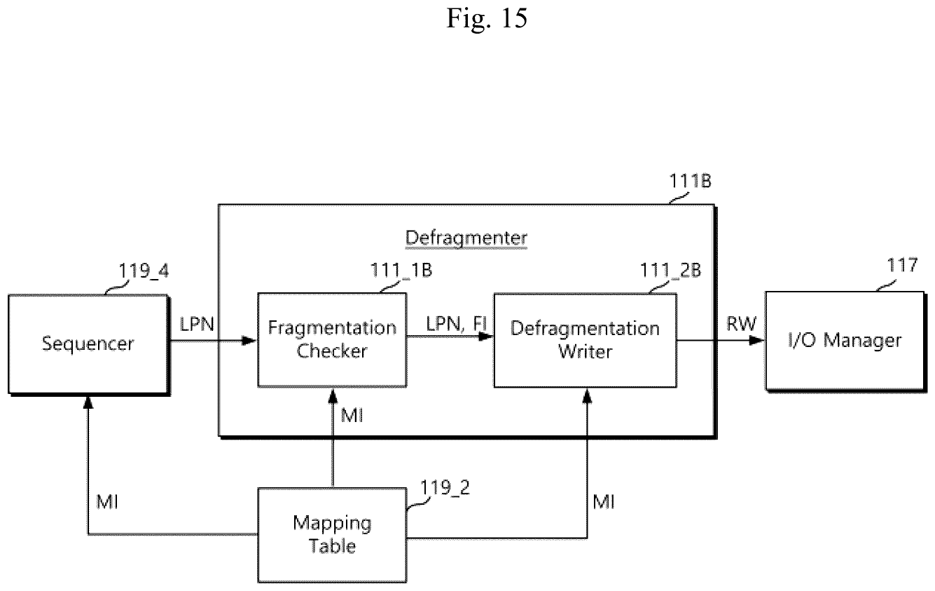

In some example embodiments, the defragmenter 111 may determine the probability of fragmentation of the user data in response to a partial write command. Some example embodiments in which the defragmenter 111 determines the probability of fragmentation of the user data in response to the partial write command and performs defragmentation together with the execution of the partial write command when it is determined that the user data are capable of being fragmented will be described in detail with reference to FIGS. 15 to 18.

In some example embodiments, the defragmenter 111 may determine fragmentation of the user data in response to a sequential read command for the user data.

The sequential read command may refer to the case where the read command for addresses continuous to a data address targeted for the read command of the host device is provided to the storage device 100 as much as a preset (or, alternatively, desired or determined) reference or more. As in the above description, a sequential write command may refer to the case where the write command for addresses continuous to a data address targeted for the write command is provided to the storage device 100 as much as the preset (or, alternatively, desired or determined) reference or more.

For example, the sequential read command may refer to the case where “m” read commands (m being a preset (or, alternatively, desired or determined) natural number of 2 or more) including continuous logical addresses are continuously received from the host device. In this case, even though the storage device 100 continuously receives a plurality of read commands including continuous logical addresses, the storage device 100 may receive the read command including any other logical address before receiving “m” read commands continuously. In this case, in some example embodiments, even in the case of receiving the read commands including other logical addresses, the number of which is smaller than or equal to “n” (n being a preset (or, alternatively, desired or determined) natural number of 1 or more) determined in advance, the storage device 100 may determine that a continuous condition of the sequential read command is not failed. In addition, the storage device 100 may determine the sequential read command by using various methods, and the present disclosure is not limited to a specific method of determining the sequential read command.

In contrast, a random read command may not be the read command for continuous addresses and may refer to the case where the read command for a random or intermittent address is received from the host device, and a random write command may not be the write command for continuous addresses and may refer to the case where the write command for a random or intermittent address is received from the host device.

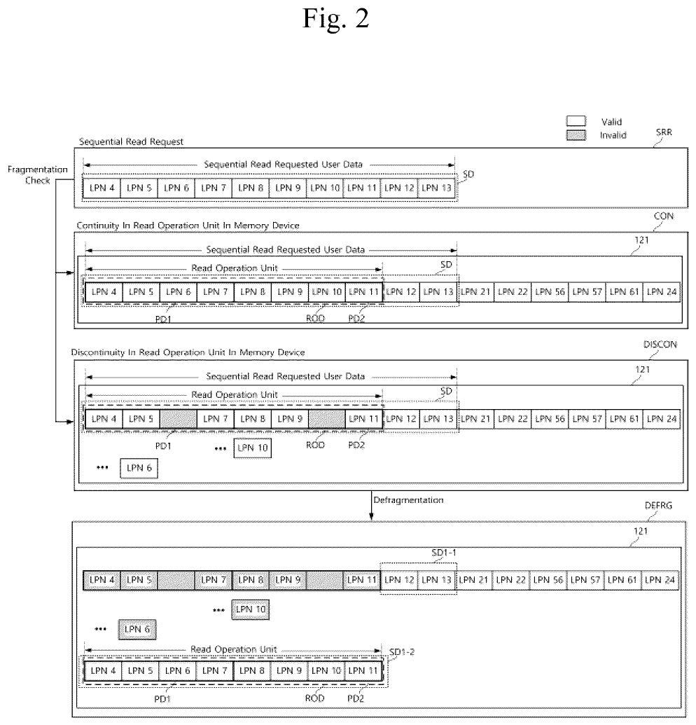

The defragmenter 111 may determine fragmentation of first user data targeted for the sequential read command from among user data. For example, user data requested by the sequential read command may be the first user data of a specific logical address range. The defragmenter 111 may determine fragmentation of the first user data of the specific logical address range. Referring to FIG. 2, in some example embodiments, in user data stored in the memory device 120, continuous user data from user data whose logical page number is 4 (LPN 4) to user data whose logical page number is 13 (LPN13) are illustrated as sequential read-requested user data SD. The defragmenter 111 may determine fragmentation of the sequential read-requested user data SD.

The defragmenter 111 may determine the continuity of a first physical address of the first user data sequentially read-requested, in the read operation unit of the memory device 120. When the first user data are stored at a plurality of first physical addresses, even though the plurality of first physical addresses corresponding to all of the first user data are not continuous, the defragmenter 111 may determine that the first user data are not fragmented.

For example, through one read operation, the memory device 120 may sense a preset (or, alternatively, desired or determined) first number of memory cells in the memory cell array 121. Through one read operation, the memory device 120 may sense a preset (or, alternatively, desired or determined) first range of memory cells in the memory cell array 121. The first range may include a plurality of corresponding pages respectively included in corresponding blocks among a plurality of memory blocks (hereinafter referred to as “blocks”) respectively included in a plurality of planes in the same bank.

That is, through one read operation, the memory device 120 may read pieces of data stored in a plurality of pages belonging to a preset (or, alternatively, desired or determined) corresponding range in blocks of each of the plurality of planes of the same bank. The read operation unit may mean the preset (or, alternatively, desired or determined) first number and/or the preset (or, alternatively, desired or determined) first range in the memory cell array 121. Accordingly, the sequential read-requested first user data may be divided into a plurality of read operation units. Alternatively, the sequential read-requested first user data may be smaller in size than one read operation unit. The read operation unit may vary depending on some example embodiments of the memory cell array 121 of the memory device 120.

Returning to FIG. 2, the storage device 100 may determine the continuity of the first physical address of the sequential read-requested first user data SD in the read operation unit of the memory device 120. For example, the storage device 100 may determine the continuity of the first physical address based on whether it is possible to read second user data ROD corresponding to the read operation unit from among the first user data SD.

For example, unlike the example illustrated in FIG. 2, the first user data SD may include a plurality of second user data. In this case, when it is possible to read each of the plurality of second user data through one corresponding read operation, the storage device 100 may determine that the first physical address of the first user data SD is continuous in the read operation unit.

When the first physical address of the first user data SD has the continuity in the read operation unit, the storage device 100 may determine that the first user data SD are not fragmented. When the first physical address of the first user data SD does not have the continuity in the read operation unit, the storage device 100 may determine that the first user data SD are fragmented.

For example, the case CON where the storage device 100 determines that the sequential read-requested first user data SD are not fragmented and the case DISCON where the storage device 100 determines that the sequential read-requested first user data SD are fragmented are illustrated in FIG. 2. FIG. 2 shows that the first user data SD include one second user data ROD corresponding to the read operation unit of the memory device 120. However, according to some example embodiments, the first user data SD may include a plurality of second user data ROD each corresponding to the read operation unit of the memory device 120.

Referring to FIG. 2, the storage device 100 may determine fragmentation of the second user data ROD corresponding to the read operation unit from among the first user data SD. The second user data ROD may include user data PD1 and PD2 respectively belonging to different planes. For example, the second user data ROD may include the user data PD1 belonging to a first plane of a 0-th bank of a 0-th channel and the user data PD2 belonging to a second plane of the 0-th bank of the 0-th channel.

Referring to FIG. 2, in the case CON where the storage device 100 determines that the sequential read-requested first user data SD are not fragmented and the case DISCON where the storage device 100 determines that the sequential read-requested first user data SD are fragmented, each rectangular box means a physical page of the memory cell array 121. It is assumed that adjacent rectangular boxes in the same page have continuous physical addresses, however, example embodiments are not limited thereto. Rectangular boxes located at different pages from among adjacent rectangular boxes may have continuous or discontinuous physical addresses depending on a physical address allocation policy. However, rectangular boxes located at different pages from among adjacent rectangular boxes may be read through one read operation of the memory device 120.

For example, referring to FIG. 2, user data whose logical page number is 7 (LPN 7) may be included in the user data PD1 and may be located at the first plane of the 0-th bank of the 0-th channel. User data whose logical page number is 8 (LPN 8) may be included in the user data PD2 and may be located at the second plane of the 0-th bank of the 0-th channel. Accordingly, the user data whose logical page number is 7 (LPN 7) and the user data whose logical page number is 8 (LPN 8) may be located at different pages but may be read through one read operation of the memory device 120.

A text in each rectangular box means a logical address of user data recorded at the corresponding physical address. A hatched rectangular box means an invalid page, and an empty rectangular box means a valid page.

Referring to FIG. 2, in the case CON where the storage device 100 determines that the sequential read-requested first user data SD are not fragmented, all pieces of second user data ROD corresponding to the read operation unit may be stored in adjacent rectangular boxes. Accordingly, because all the first physical addresses of the pieces of second user data ROD are continuous in the read operation unit, the storage device 100 may determine that the first user data SD corresponding to the read operation unit are not fragmented.

Referring to FIG. 2, in the case DISCON where the storage device 100 determines that the sequential read-requested first user data SD are fragmented, some of the pieces of second user data ROD corresponding to the read operation unit may be stored in blocks not adjacent to each other.

For example, user data whose logical page number is 6 (LPN 6) and user data whose logical page number 10 (LPN 10) may be stored at physical addresses not continuous to any other user data constituting the first user data SD in the read operation unit. Accordingly, because some of the first physical addresses of the pieces of second user data ROD are not continuous in the read operation unit, the storage device 100 may determine that the first user data SD are fragmented.

When the first user data SD are fragmented, the defragmenter 111 may perform defragmentation of the first user data SD. For example, the defragmenter 111 may store the second user data ROD corresponding to the read operation unit from among the first user data SD at a second physical address continuous in the read operation unit of the memory device 120 of FIG. 2. The first physical address of the second user data ROD corresponding to the read operation unit may be discontinuous in the read operation unit.

That is, the storage device 100 may determine that the first user data SD are fragmented in the read operation unit; when it is determined that the first user data SD are fragmented (DISCON), the storage device 100 may perform defragmentation of the first user data SD in the read operation unit; and the storage device 100 may store at least a portion of the first user data SD in a state where the first user data SD are not fragmented (DEFRAG).

For example, referring to FIG. 2, the defragmenter 111 may store pieces of second user data ROD corresponding to the read operation unit from among the first user data SD of the fragmented case (DISCON) at the second physical address in which a physical address is continuous in the read operation unit.

The second physical address may be continuous in the read operation unit. For example, continuous physical address in the read operation unit may mean the preset (or, alternatively, desired or determined) first number and/or the preset (or, alternatively, desired or determined) first range. Because the defragmenter 111 determines fragmentation of the first user data SD in the read operation unit, the defragmenter 111 is allocated a free block satisfying the first range, and may store the pieces of second user data ROD corresponding to the read operation unit from among the first user data SD in the allocated free block. As described above, the first range may be a range of cells of the memory cell array 121, which the memory device 120 is able to read through one read operation. For example, the first range of the memory device 120 may include a plurality of corresponding pages respectively included in blocks corresponding to each other from among a plurality of memory blocks respectively included in a plurality of planes in the same bank. The first range may vary depending on some example embodiments of the memory device 120.

Referring to FIG. 2, in the case where the first user data SD are not fragmented (CON), the storage device 100 performs the read operation two times to read the sequential read-requested user data SD. Also, when the defragmentation of the first user data SD is performed (DEFRAG), likewise, the storage device 100 performs the read operation two times to read sequential read-requested user data SD1-1 and SD1-2. Accordingly, the read operation of the memory device 120 is performed as much as the same number of times to read the sequential read-requested user data.

Also, in the case where the first user data SD are fragmented (DISCON), some user data among the first user data SD are not moved during the defragmentation operation. That is, the user data whose logical page number is 12 (LPN 12) and the user data whose logical page number is 13 (LPN 13) are not moved during the defragmentation operation. Accordingly, the overhead due to the defragmentation may be reduced.

According to some example embodiments of the present disclosure, the storage device 100 may determine the fragmentation of user data sequential read-requested in the read operation unit of the memory device 120 and may perform the defragmentation of the fragmented user data in the read operation unit of the memory device 120. Accordingly, when the storage device 100 determines the fragmentation of the user data, the storage device 100 may not consider the whole sequential read-requested user data once. The storage device 100 may divide the sequential read-requested user data in the read operation unit to determine the fragmentation.

Also, when it is determined that the fragmentation is made, the storage device 100 may not perform the defragmentation of the whole sequential read-requested user data. The storage device 100 may store fragmented user data among the sequential read-requested user at any other physical address in the read operation unit.

Accordingly, the storage device 100 may improvably and/or more efficiently perform the defragmentation of the sequential read-requested user data. That is, the process and/or efficiency of defragmentation may be improved by defragmenting not the whole sequential read-requested user data but a portion of the sequential read-requested user data (e.g., in the read operation unit of the memory device 120). For example, according to some example embodiments, there may be an increase in reliability, operating parameters, speed, accuracy, and/or power efficiency of the memory device based on the above methods. Therefore, the improved devices and methods overcome the deficiencies of the conventional devices and methods while reducing resource consumption, and/or improving data accuracy, operating parameters, and resource allocation (e.g., latency).

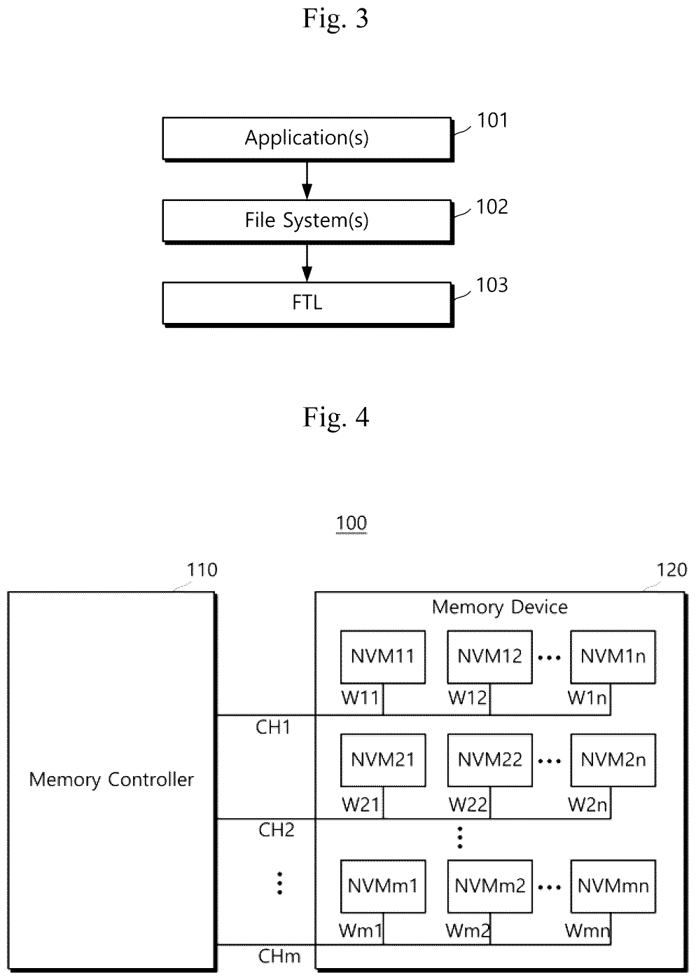

FIG. 3 is a diagram illustrating a software architecture of a storage device of FIG. 1.

Referring to FIGS. 1 and 3, the software architecture of the storage device 100 may include an application 101, a file system 102, and a flash translation layer (FTL) 103. In some example embodiments, the application 101 and the file system 102 may be included in an external device (e.g., a host) or may be driven by the external device.

The application 101 may include various programs which are driven on an operating system (OS) of the external device. For example, the application 101 may include various programs such as a text editor, an image player, and a web browser.

The file system 102 may perform a role of organizing files or data which are used by the application 101. For example, the file system 102 may provide an address of a file or data. In some example embodiments, the address may be a logical address which is organized or managed by the external device.

The flash translation layer 103 provides an interface between the external device and the memory device 120 such that the memory device 120 is used, for example, is used more efficiently based on some example embodiments. For example, the flash translation layer 103 may perform an operation of translating a logical address provided from the external device into a physical address usable in the memory device 120. For example, the flash translation layer 103 may manage the address translation operation through a mapping table.

In some example embodiments, the operations for defragmentation described with reference to FIG. 1 may be performed based on the flash translation layer 103. For example, the memory controller 110 of FIG. 1 may check the sequential read command based on the flash translation layer 103. The memory controller 110 may determine the fragmentation of the sequential read-requested user data in the read operation unit of the memory device 120, based on the flash translation layer 103. The memory controller 110 may control the memory device 120 in the read operation unit of the memory device 120 and may perform the defragmentation of the sequential read-requested user data in the read operation unit of the memory device 120.

FIG. 4 is a diagram illustrating a configuration according to some example embodiments of a memory device according to some example embodiments of the present disclosure. The storage device 100 of FIG. 4 may correspond to the storage device 100 of FIG. 1.

The memory controller 110 may perform an I/O for a plurality of memory devices NVM11 to NVMmn through a plurality of channels CH1 to CHm. The memory device 120 and the memory controller 110 may be connected through the plurality of channels CH1 to CHm. In some example embodiments, the memory controller 110 may include a plurality of controller modules respectively corresponding to the plurality of channels CH1 to CHm.

The memory controller 110 may control a memory device (e.g., one of NVM11 to NVMmn) connected to one of the plurality of channels CH1 to CHm through a way.

The memory controller 110 may exchange signals with the memory device 120 through the plurality of channels CH1 to CHm.

The memory device 120 may include a plurality of nonvolatile memory devices NVM11 to NVMmn. Each of the nonvolatile memory devices NVM11 to NVMmn may be a nonvolatile memory package. In some example embodiments, each of the nonvolatile memory devices NVM11 to NVMmn may include a plurality of dies, but the present disclosure is not limited thereto.

In some example embodiments, each of the plurality of channels CH1 to CHm may include a plurality of banks. Each of the plurality banks may include a plurality of planes. Each of the planes may include a plurality of blocks. Each of the blocks may include a plurality of pages.

The memory device 120 according to some example embodiments of the present disclosure may read data from cells from a plurality of pages of different planes in the read operation unit. The memory device 120 may program data at a plurality of pages of different planes in the read operation unit.

As described with reference to FIGS. 1 and 2, the memory controller 110 may control the memory device 120 to determine the fragmentation of user data, which are sequential read-requested in the read operation unit, in the read operation unit and to perform the defragmentation of the sequential read-requested user data. The memory device 120 may read and program the user data stored at cells of a plurality of pages of different planes in the read operation unit.

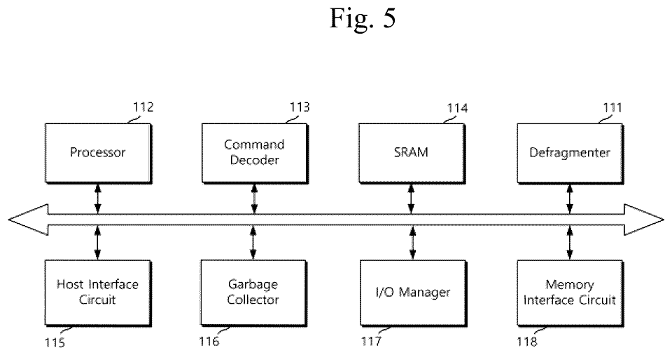

FIG. 5 is a diagram illustrating a configuration of a memory controller according to some example embodiments of the present disclosure. The memory controller 110 to be described with reference to FIG. 5 may correspond to the memory controller 110 of the storage device 100 of FIG. 1.

The memory controller 110 may include the defragmenter 111, a processor 112, a command decoder 113, a static random access memory (SRAM) 114, a host interface circuit 115, a garbage collector 116, an input/output manager 117, and a memory interface circuit 118. Although not illustrated in FIG. 5, the memory controller 110 may further include a flash translation layer (FTL), a packet manager, an error correction code (ECC) circuit, and/or a working memory device.

In some example embodiments, the defragmenter 111, the command decoder 113, the garbage collector 116, and/or the input/output manager 117 may be implemented as an independent circuit and/or a portion of firmware.

The processor 112 may be implemented with a circuit, logic, a code, or a combination thereof. The processor 112 controls all the operations of the storage device 100 including the memory controller 110. When the storage device 100 is driven, the processor 112 may load the firmware stored in a read only memory (ROM) to the working memory device and may perform all the operations of the memory controller 110. The processor 112 may load the flash translation layer to the working memory device; based on an address translation result of the flash translation layer, the processor 112 may program data in the memory device 120 and/or may read data from the memory device 120.

The memory controller 110 may communicate with the host through the host interface circuit 115. The host interface circuit 115 may be implemented with various interface manners such as advanced technology attachment (ATA), serial ATA (SATA), external SATA (e-SATA), small computer small interface (SCSI), serial attached SCSI (SAS), peripheral component interconnection (PCI), PCI express (PCIe), IEEE 1394, universal serial bus (USB), NVMe, and CXL.

The command decoder 113 may decode a command parsed from the command, based on the protocol of the interface negotiated on the host. The command decoder 113 may parse the command from the packet received from the host, based on the protocol of the interface negotiated on the host. For example, the command decoder 113 may decode an opcode of the command which is based on a specific protocol and may identify a program command, an erase command, a read command, and/or a secure erase command. The processor 112 may perform the request of the host depending on the decoded commands. The command decoder 113 may be implemented as an independent circuit and/or a portion of firmware.

The flash translation layer may perform various functions such as address mapping, wear-leveling, and/or garbage collection.

The address mapping operation refers to an operation of translating a logical address received from the host into a physical address to be actually used to program data in the memory device 120. For example, a logical block address (LBA) of user data which are requested by the host to be programmed may be translated into a physical address of the memory device 120 of FIG. 1 by using the flash translation layer. In some example embodiments, the physical address may be a physical page number (PPN). In some example embodiments, the mapping table which the flash translation layer manages may store a mapping relationship between a logical page number (LPN) and a physical page number. In some example embodiments, each of logical page numbers LPN may correspond to a plurality of logical block addresses LBA.

The wear-leveling which is a technology for allowing blocks of the memory device 120 of FIG. 1 to be used uniformly such that degradation (e.g., degradation or excessive degradation beyond expected usage patterns) of a specific block is prevented or reduced may be implemented, for example, through a firmware technology for balancing erase counts of physical blocks.

The working memory device (not illustrated) may include a register for storing internal variables of the memory controller 110 and/or a buffer memory for performing an operation of the storage device 100. In some example embodiments, the working memory device which operates as a buffer memory may temporarily store data to be recorded at the memory device 120 of FIG. 1 or data read from the memory device 120 of FIG. 1. The working memory device may be implemented with a volatile memory device. According to some example embodiments, the working memory device may be disposed inside and/or outside the memory controller 110. Alternatively, when the host buffer memory is provided by the host, the working memory device may not operate as a buffer memory.

The ECC circuit may generate parity information by performing ECC encoding for data to be programmed in the memory device 120 of FIG. 1 and may add the parity information to the data. Also, the ECC circuit may detect an error bit from the data read from the memory device 120. For example, the memory controller 110 may detect an error bit by performing ECC decoding for the read data. In some example embodiments, the memory device 120 of FIG. 1 may include an on-die ECC circuit. In some example embodiments, the ECC circuit may be implemented as an independent circuit and/or a portion of firmware.

The memory controller 110 according to some example embodiments of the present disclosure may include the defragmenter 111.

The defragmenter 111 may determine the fragmentation of the sequential read-requested user data in the read operation unit of the memory device 120 of FIG. 1. The defragmenter 111 may determine the continuity of a physical address of the sequential read-requested user data in the read operation unit of the memory device 120.

The defragmenter 111 may store at least a portion determined as fragmented in the read operation unit of the memory device 120 of FIG. 1 at any other physical address of the memory device 120. The physical address of the newly stored user data may be continuous in the read operation unit.

That is, as described with reference to FIG. 1, the defragmenter 111 may determine the fragmentation of user data corresponding to the read operation unit from among the sequential read-requested user data. When the user data corresponding to the read operation unit are fragmented, the defragmenter 111 may perform the defragmentation of the user data corresponding to the read operation unit. According to some example embodiments, a portion of the user data may not be moved to any other physical address in the defragmentation operation.

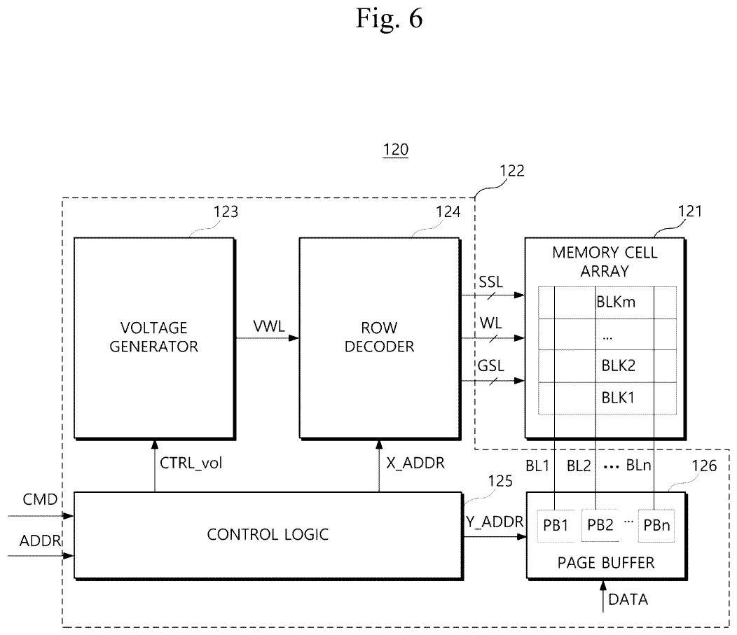

FIG. 6 is a diagram illustrating a configuration according to some example embodiments of a memory device according to some example embodiments of the present disclosure. The memory device 120 to be described with reference to FIG. 6 may correspond to the memory device 120 of FIG. 1.

Referring to FIG. 6, the memory device 120 may include the memory cell array 121, a voltage generator and row decoder 122, control logic 125, a page buffer block 126. The voltage generator and row decoder 122 may include a voltage generator 123 and a row decoder 124.

The control logic 125 may overall control various kinds of operations of the memory device 120. The control logic 125 may output various kinds of control signals in response to a command CMD and/or a physical address ADDR received from the memory interface circuit 118 of FIG. 5. For example, the control signals may include a voltage control signal CTRL_vol, a row address X_ADDR, and a column address Y_ADDR.

The command CMD may be an internal command which the memory controller 110 of FIG. 1 transmits.

The memory cell array 121 may include a plurality of memory blocks BLK1 to BLKm (m being a positive integer), and each of the plurality of memory blocks BLK1 to BLKm may include a plurality of memory cells. The memory blocks BLK1 to BLKm may be connected to the page buffer block 126 through bit lines BL1 to BLn and may be connected to the row decoder 124 through word lines WL, string selection lines SSL, and ground selection lines GSL.

The page buffer block 126 may include a plurality of page buffers PB1 to PBn (n being an integer of 3 or more), and the plurality of page buffers PB1 to PBn may be connected to memory cells included in each of the plurality of memory blocks BLK1 to BLKm through the plurality of bit lines BL1 to BLn. The page buffer block 126 may select at least one of the bit line BL1 to BLn in response to the column address Y_ADDR. The page buffer block 126 may operate as a write driver or a sense amplifiers depending on an operation mode. For example, in the program operation, the page buffer block 126 may apply a bit line voltage corresponding to data “DATA” to be programmed to the selected bit line. In the read operation, the page buffer block 126 may sense a current or a voltage of the selected bit line to read data stored in a memory cell. The plurality of page buffers PB1 to PBn of the page buffer block 126 may sense data stored in memory cells through the plurality of bit lines BL1 to BLn and may temporarily store the sensed data as sensing data.

The voltage generator 123 may generate various kinds of voltages for performing the program operation, read operation, the erase operation, etc. based on the voltage control signal CTRL_vol.

In response to the row address X_ADDR, the row decoder 124 may select one of the plurality of word lines WL and may select one of the plurality of string selection lines SSL.

The memory device 120 according to some example embodiments of the present disclosure may read data from a plurality of memory cells in the read operation unit. Some of a plurality of memory pages of the memory cell array 121 may be respectively located at different planes but may be sensed by one read operation. Also, the memory device 120 may program user data in a plurality of memory cells of the memory cell array 121 in the read operation unit. Some of the plurality of memory pages of the memory cell array 121 may be respectively located at different planes but may be programmed by one write operation.

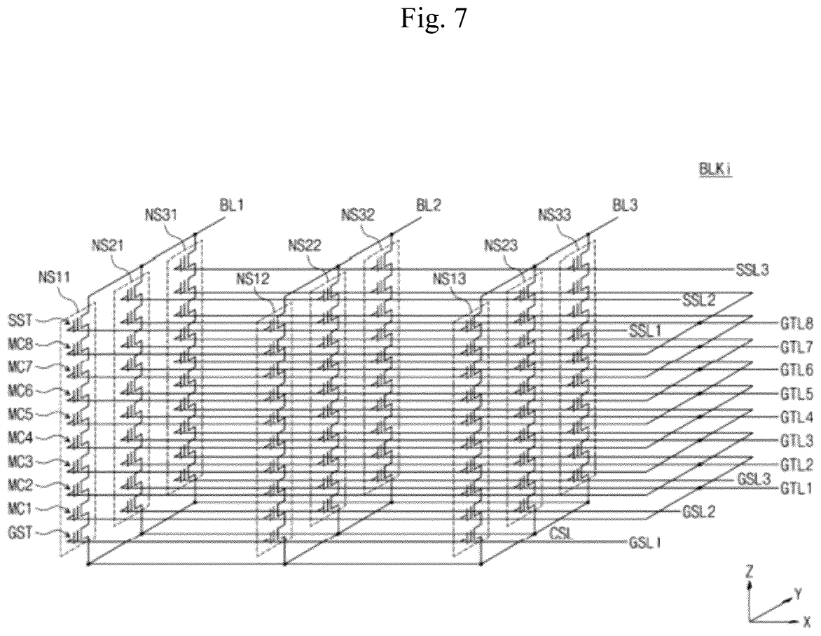

FIG. 7 is a diagram illustrating a configuration according to some example embodiments of a memory block according to some example embodiments of the present disclosure. A memory block BLKi of FIG. 7 may be one of the memory blocks BLK1 to BLKm included in the memory cell array 121 of the memory device 120 of FIG. 1.

When the memory device 120 of the storage device 100 of FIG. 1 is implemented with a flash memory of a 3D V-NAND type, each of a plurality of memory blocks constituting the memory device 120 may be expressed by an equivalent circuit illustrated in FIG. 7.

The memory block BLKi illustrated in FIG. 7 indicates a three-dimensional memory block formed on a substrate in a three-dimensional structure. For example, a plurality of memory NAND strings included in the memory block BLKi may be formed in a direction perpendicular to the substrate.

Referring to FIG. 7, the memory block BLKi may include a plurality of memory NAND strings NS11 to NS33 connected between bit line BL1, BL2, and BL3 and a common source line CSL. Each of the plurality of memory NAND strings NS11 to NS33 may include a string selection transistor SST, a plurality of memory cells MC1, MC2, . . . , MC8, and a ground selection transistor GST. Some example embodiments in which each of the plurality of memory NAND strings NS11 to NS33 includes eight memory cells MC1, MC2, . . . , MC8 is illustrated in FIG. 7, but some example embodiments of the present disclosure is not necessarily limited thereto.

The string selection transistor SST may be connected to a corresponding one of string selection lines SSL1, SSL2, and SSL3. The plurality of memory cells MC1, MC2, . . . , MC8 may be respectively connected to gate lines GTL1, GTL2, . . . , GTL8. The gate lines GTL1, GTL2, . . . , GTL8 may correspond to word lines.

In some example embodiments, some of the gate lines GTL1, GTL2, . . . , GTL8 may correspond to dummy word lines. The ground selection transistor GST may be connected to a corresponding one of ground selection lines GSL1, GSL2, and GSL3. The string selection transistor SST may be connected to a corresponding bit line among the bit lines BL1, BL2, and BL3, and the ground selection transistor GST may be connected to the common source line CSL.

Word lines (e.g., WL1) at the same height may be connected in common, and the ground selection lines GSL1, GSL2, and GSL3 and the string selection lines SSL1, SSL2, and SSL3 may be separated from each other. An example in which the memory block BLKi is connected to eight gate lines GTL1, GTL2, . . . , GTL8 and three bit lines BL1, BL2, and BL3 is illustrated in FIG. 7, but some example embodiments of the present disclosure is not necessarily limited thereto.

The bit density of the memory block BLKi may vary depending on the number of bits which each of the memory cells included in the memory block BLKi stores.

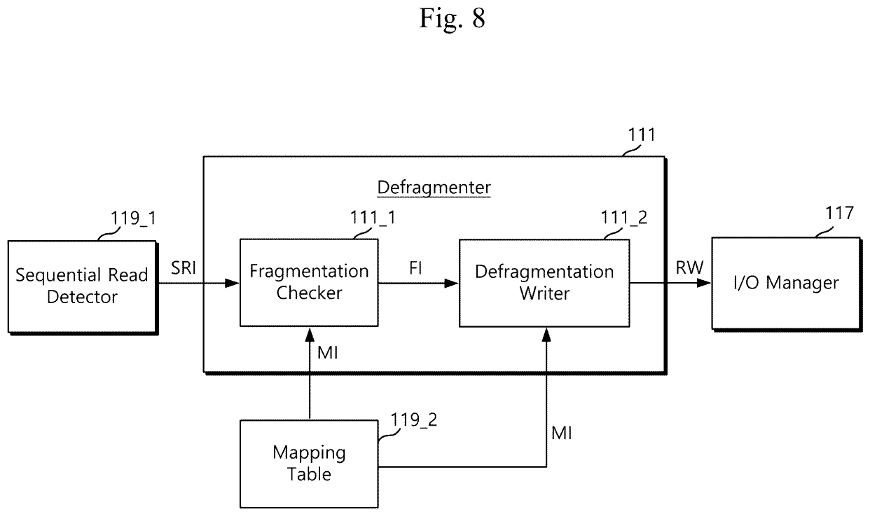

FIG. 8 is a diagram describing a configuration according to some example embodiments of a defragmenter according to some example embodiments of the present disclosure. A defragmenter to be described with reference to FIG. 8 may correspond to the defragmenter 111 of FIGS. 1 and 5.

The defragmenter 111 according to some example embodiments of the present disclosure may include a fragmentation checker 111_1 and a defragmentation writer 111_2.

The fragmentation checker 111_1 may indirectly or directly receive sequential read information SRI from a sequential read detector 119_1.

The sequential read detector 119_1 may determine the sequential read command based on continuously receiving read commands including continuous logical addresses from the host device, as described with reference to FIG. 1. The sequential read detector 119_1 may determine sequential read-requested user data based on the sequential read command. The sequential read detector 119_1 may include a logical address or a physical address of the sequential read-requested user data in the sequential read information SRI and may provide the sequential read information SRI to the fragmentation checker 111_1. The sequential read detector 119_1 may be implemented as an independent circuit and/or a portion of firmware.

The fragmentation checker 111_1 may determine the fragmentation of the sequential read-requested user data in the read operation unit of the memory device 120. When the sequential read-requested user data correspond to a plurality of read operation units, the fragmentation checker 111_1 may divide the user data in the read operation unit and may determine the fragmentation of the user data in the read operation unit.

For example, sequential read-requested first user data may include a plurality of second user data of the read operation unit. The fragmentation checker 111_1 may determine the fragmentation of each of the plurality of second user data of the read operation unit. Below, the description will be given with reference to FIG. 8 under the assumption that the sequential read-requested first user data include at least one second user data of the read operation unit.

The fragmentation checker 111_1 may determine the fragmentation of user data in the read operation unit, based on a mapping table 119_2 in which a mapping relationship between a logical address and a physical address is stored.

For example, when the sequential read-requested first user data include the plurality of second user data of the read operation unit and at least one of the plurality of second user data is incapable of being read through one read operation, the fragmentation checker 111_1 may determine that the first user data are fragmented.

The fragmentation checker 111_1 may generate information of the second user data, which are incapable of being read through one read operation, from among the first user data as fragmentation information FI and may indirectly or directly transmit the fragmentation information FI to the defragmentation writer 111_2.

The fragmentation information FI may include a logical address and/or a physical address of the second user data.

The defragmentation writer 111_2 may generate information RW, which directs the input/output manager 117 to store the fragmented second user data at a new physical address, based on the fragmentation information FI and mapping information MI received from the mapping table 119_2. The defragmentation writer 111_2 may indirectly or directly transmit the information RW indicating to store of the second user data at the new physical address to the input/output manager 117.

In some example embodiments, the information RW indicating to store of the second user data at the new physical address may include a logical address of the second user data and a new physical address at which the second user data will be stored.

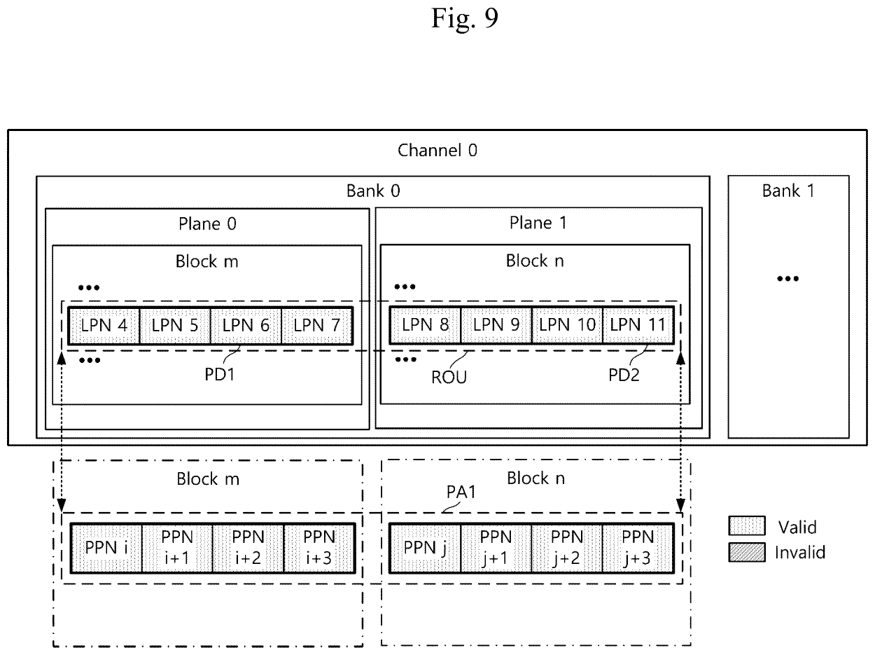

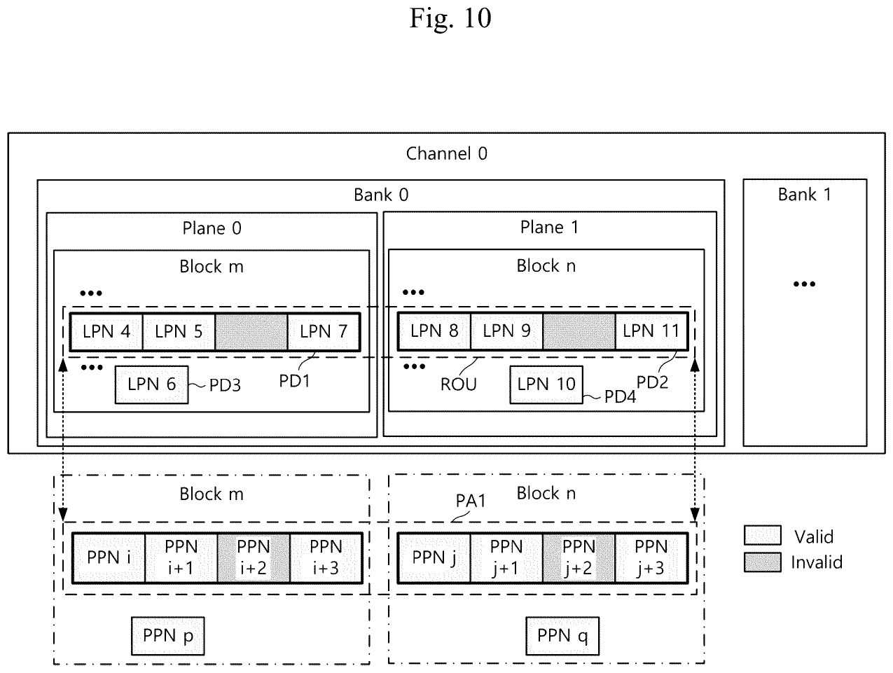

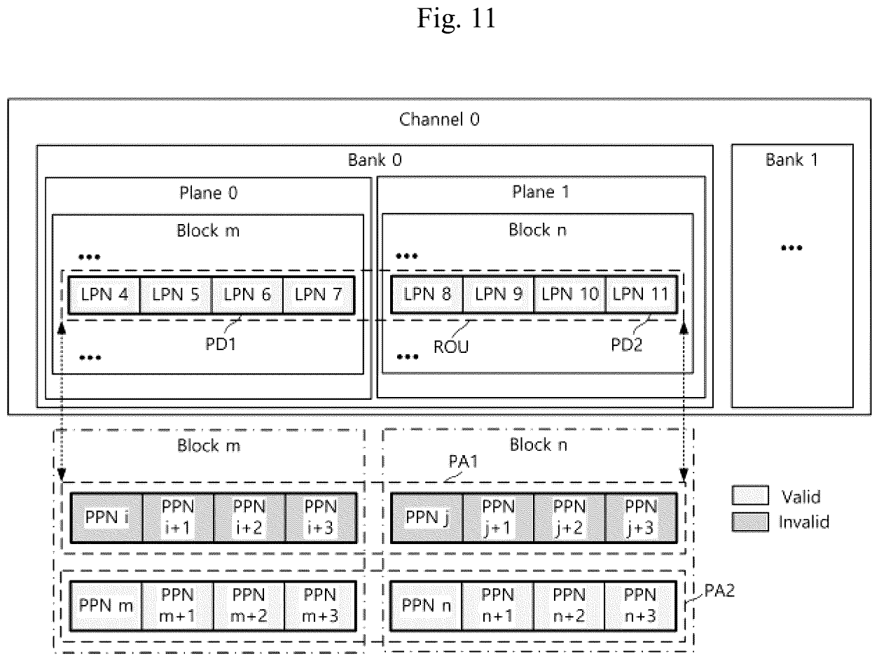

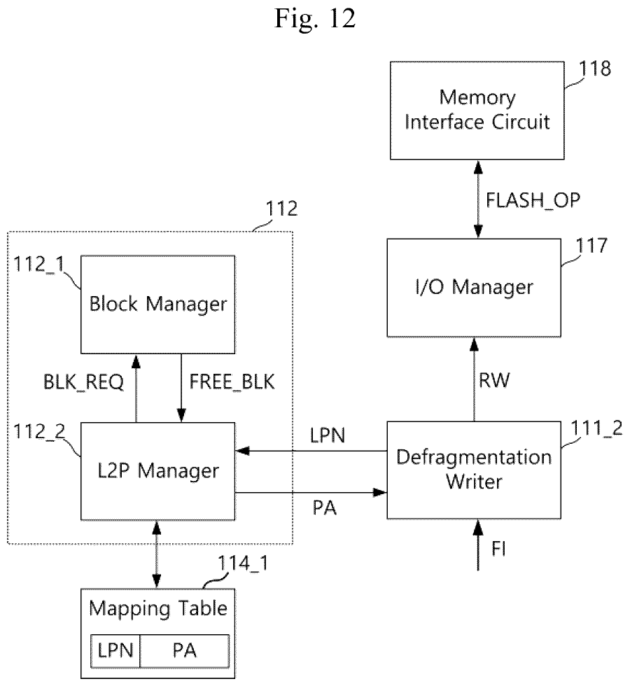

FIG. 9 is a diagram describing user data with continuity, according to some example embodiments of the present disclosure, and FIG. 10 is a diagram describing user data with discontinuity, according to some example embodiments of the present disclosure. FIG. 11 illustrates a result of performing defragmentation on user data of FIG. 10.

In FIGS. 9 to 11, second user data LPN 4 to LPN 11 are illustrated as being stored in the memory cell array 121 of FIG. 1. In FIGS. 9 to 11, a dotted rectangular box means a valid page, and a hatched rectangular box means an invalid page. In FIGS. 9 to 11, signs in a box marked by a long dashed line indicate logical page numbers of the second user data LPN 4 to LPN 11 stored at respective pages, and signs in a box marked by a dash-dotted line indicate physical page numbers at which the second user data LPN 4 to LPN 11 are stored. For example, in FIG. 9, the second user data whose logical page number is 4 (LPN 4) is illustrated as being stored at a page whose physical page number is i (PPN i).

A method in which the fragmentation checker 111_1 of the defragmenter 111 determines the fragmentation of the second user data LPN 4 to LPN 11 will be described with reference to FIGS. 9 and 10. Below, the description will be given with reference to FIGS. 9 and 10 under the assumption that the sequential read-requested first user data includes the second user data LPN 4 to LPN 11 of the read operation unit ROU.

Referring to FIG. 9, all the second user data LPN 4 to LPN 11 of the read operation unit may be stored at a valid page. The second user data LPN 4 to LPN 11 may be stored as user data PD1 and PD2 located at different blocks Block m and Block n of different planes Plane 0 and Plane 1. For convenience, in the description given with reference to FIGS. 9 to 11, second user data stored in an m-th block Block m are referred to as “first partial data PD1”, and second user data stored in an n-th block Block n are referred to as “second partial data PD2”.

The first partial data PD1 and the second partial data PD2 may be stored in different planes; however, because the first partial data PD1 and the second partial data PD2 are included in the same second user data LPN 4 to LPN 11 and all the user data of the second user data LPN 4 to LPN 11 correspond to the read operation unit ROU, the first partial data PD1 and the second partial data PD2 may be read by the one read operation.

Referring to FIG. 9, logical page numbers of pieces of user data constituting the first partial data PD1 are continuous from LPN 4 to LPN 7, and physical page numbers thereof are continuous from PPN i to PPN i+3. Likewise, logical page numbers of pieces of user data constituting the second partial data PD2 are continuous from LPN 8 to LPN 11, and physical page numbers thereof are continuous from PPN j to PPN j+3. Accordingly, the fragmentation checker 111_1 of FIG. 8 may determine that the physical address of the second user data LPN 4 to LPN 11 is continuous in the read operation unit. The fragmentation checker 111_1 may determine that the second user data LPN 4 to LPN 11 are not fragmented.

Referring to FIG. 10, all the second user data LPN 4 to LPN 11 are stored at a valid page. Unlike the example of FIG. 9, the second user data LPN 4 to LPN 11 may be composed of four partial data PD1, PD2, PD3, and PD4 and may be stored in blocks Block m and Block n.

The first partial data PD1 and the third partial data PD3 are stored in the m-th block Block m of the 0-th plane Plane 0, and the second partial data PD2 and the fourth partial data PD4 are stored in the n-th block Block n of the first plane Plane 1. For example, when data of pages whose logical page numbers are 6 and 10 from among the second user data LPN 4 to LPN 11 of FIG. 9 are revised by the host device, the second user data LPN 4 to LPN 11 may be stored as illustrated in FIG. 10.

Referring to FIG. 10, the physical address of the second user data LPN 4 to LPN 11 is not continuous to each other in the read operation unit. For example, because the user data whose logical page number is 6 (LPN 6) are stored at a page whose physical page number is p (PPN p), the physical address of the user data whose logical page numbers are 5 (LPN 5) and 7 (LPN 7) is not continuous.

That is, the second user data LPN 4 to LPN 11 may be incapable of being read through one read operation. The first partial data PD1 and the second partial data PD2 may correspond to the same read operation unit ROU, but the third partial data PD3 and the fourth partial data PD4 are incapable of being read in the read operation unit ROU corresponding to the first partial data PD1 and the second partial data PD2.

Accordingly, the fragmentation checker 111_1 of FIG. 8 may determine that the physical address of the second user data LPN 4 to LPN 11 is not continuous in the read operation unit. The fragmentation checker 111_1 may determine that the second user data LPN 4 to LPN 11 are fragmented.

A method in which the fragmentation checker 111_1 of the defragmenter 111 of FIG. 8 perform the defragmentation of the second user data LPN 4 to LPN 11 will be described with reference to FIGS. 10 and 11.

Referring to FIG. 10, the fragmentation checker 111_1 may check the user data LPN 6 and LPN 10 whose physical address is not continuous, from among the second user data LPN 4 to LPN 11. For example, the fragmentation checker 111_1 may compare a physical address of each user data of the second user data LPN 4 to LPN 11 with a physical address of preceding user data and following user data in a logical address order. As a comparison result, the fragmentation checker 111_1 may determine the user data LPN 6 and LPN 10 whose physical address is not continuous.

Referring to FIG. 10, the fragmentation checker 111_1 may be allocated a free block in which the second user data LPN 4 to LPN 11 will be stored. The free block may be a free block whose size corresponds to the read operation unit ROU. The fragmentation checker 111_1 may store the second user data LPN 4 to LPN 11 including the user data LPN 6 and LPN 10 at a physical address PA2 of the free block. A previous physical address PA1 where the second user data LPN 4 to LPN 11 are stored may be stored in meta information as an invalid page.

FIG. 12 is a diagram describing a defragmentation writer according to some example embodiments of the present disclosure. A defragmentation writer to be described with reference to FIG. 12 may correspond to the defragmentation writer 111_2 of FIG. 8. The defragmentation writer 111_2 will be described with reference to FIG. 12.

Functions and operations of the components of FIG. 12 may be accomplished by functions and operations of components different from the components of FIG. 12 depending on various implementations of the present disclosure. Accordingly, the components of FIG. 12 and messages and/or pieces of data which are transmitted between the components may be implemented by a method different from that of FIG. 12.

Referring to FIG. 12, the defragmentation writer 111_2 may receive the fragmentation information FI and may generate the information RW directing the input/output manager 117 to store user data at a new physical address, based on the fragmentation information FI. For example, the defragmentation writer 111_2 may generate the information RW indicating to store the second user data LPN 4 to LPN 11, which are fragmented as described with reference to FIG. 11, at the new physical address PA2. Below, the description will be given with reference to FIG. 12 under the assumption that the defragmentation writer 111_2 generates the information RW indicating to store the second user data LPN 4 to LPN 11 of FIG. 10 at the new physical address PA2 as illustrated in FIG. 11.

The defragmentation writer 111_2 may transmit at least one logical address LPN of the second user data LPN 4 to LPN 11 to an L2P manager 112_2 and may receive a new physical address PA from the L2P manager 112_2.

The L2P manager 112_2 may search for a free block based on a mapping table 114_1 to determine the physical address PA to which the at least one logical address LPN will be allocated. The L2P manager 112_2 may search the mapping table 114_1 for the physical address PA corresponding to the logical address LPN. The L2P manager 112_2 may allocate the physical address PA corresponding to the logical address LPN and may update the mapping table 114_1.

In some example embodiments, when there is no free block FREE_BLK in which data will be written, the L2P manager 112_2 may transmit a block request BLK_REQ to a block manager 112_1 and may be provided with the free block FREE_BLK from the block manager 112_1.

The L2P manager 112_2 may determine the physical address PA continuous in the read operation unit such that a memory device reads all the second user data LPN 4 to LPN 11 through one read operation.

The defragmentation writer 111_2 may generate the information RW directing to store the fragmented second user data LPN 4 to LPN 11 at the physical address PA, based on the physical address PA received from the L2P manager 112_2.

The input/output manager 117 may temporarily store a plurality of inputs/outputs of the memory device in a buffer memory. In some example embodiments, for example, based on the information RW which the defragmentation writer 111_2 transmits, the input/output manager 117 may generate at least one internal command for storing the second user data LPN 4 to LPN 11 at the physical address PA of the memory device and may temporarily store the at least one internal command in the buffer memory. The input/output manager 117 may convert the at least one internal command in a form FLASH_OP suitable for the write operation of the memory device 120 of FIG. 1 so as to be stored in the memory device 120 through the memory interface circuit 118.

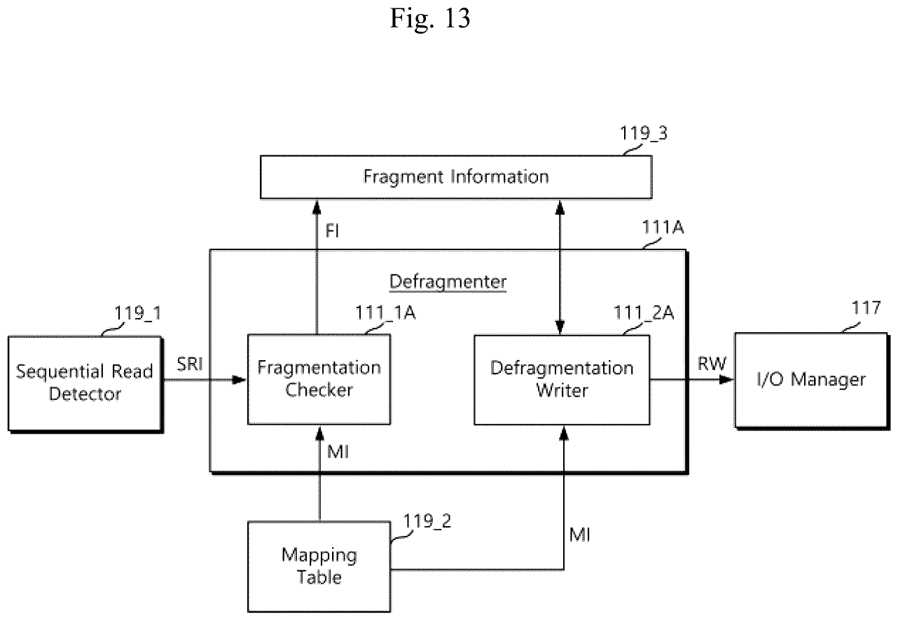

FIG. 13 is a diagram describing a configuration according to some example embodiments of a defragmenter according to some example embodiments of the present disclosure. A defragmenter to be described with reference to FIG. 13 may correspond to the defragmenter 111 of FIGS. 1 and 5. A defragmenter 111A will be described with reference to FIG. 13. Detailed description associated with components the same as or similar to those described above will be omitted to avoid redundancy. The defragmenter 111A will be described based on a difference with the defragmenter 111 described with reference to FIG. 8.

Unlike the defragmenter 111 of FIG. 8, the defragmenter 111A according to some example embodiments of the present disclosure may store information about fragmentation of user data as separate fragmentation information 119_3 being meta information.

When a defragmentation writer 111_2A performs defragmentation, the defragmentation writer 111_2A may perform defragmentation by referring to the fragmentation information 119_3. The fragmentation information 119_3 may include information of user data determined as being fragmented in the read operation unit from among the sequential read-requested user data.

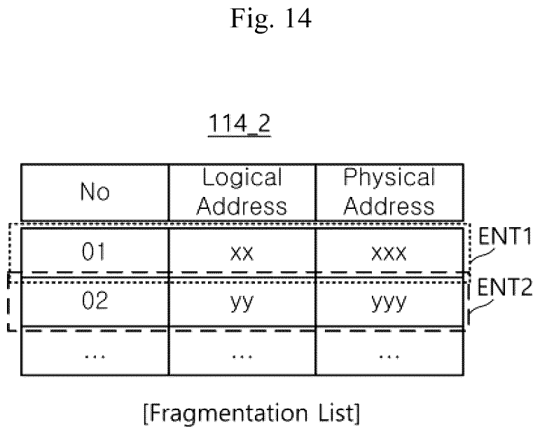

In some example embodiments, fragmentation information may be implemented in the form of a fragmentation list including information of pieces of fragmented user data. For example, the fragmentation information may include a plurality of entries ENT1, ENT2, etc. as illustrated in FIG. 14, and each of the entries ENT1, ENT2, etc. may include information of fragmented user data. For example, each of the entries ENT1, ENT2, etc. may include a logical address and/or a physical address of fragmented user data. According to some example embodiments, the physical address may not be included.

For example, the first entry ENT1 may include a logical address of fragmented user data. The logical address of the fragmented user data may be a logical address of all pages included in the fragmented user data. Alternatively or additionally, the logical address of the fragmented user data may be a logical address of the first page of the fragmented user data. In this case, the defragmentation writer 111_2A may perform defragmentation of pieces of user data from the logical address of the first page to a logical address obtained by adding a data size corresponding to the read operation unit.

In some example embodiments, without performing the defragmentation of user data immediately after the fragmentation information 119_3 is generated, the defragmentation writer 111_2A may perform the defragmentation by referring the fragmentation information 119_3 when a preset (or, alternatively, desired or determined) condition is satisfied.

In some example embodiments, the preset (or, alternatively, desired or determined) condition may include a condition that a storage device enters an idle state. For example, when a memory device enters an idle state where an operation (e.g., the read operation, the write operation, etc.) is not performed based on a request received from a host device, the defragmentation of fragmented user data may be performed by referring to the fragmentation information 119_3.

In some example embodiments, the preset (or, alternatively, desired or determined) condition may include a condition that garbage collection is performed. For example, the garbage collector 116 of FIG. 5 may perform the defragmentation of the fragmented user data by referring to the fragmentation information 119_3 while performing garbage collection.

For example, when it is determined based on the fragmentation information 119_3 that the fragmented user data are present in a source block where garbage collection will be performed, the garbage collector 116 of FIG. 5 may store pieces of user data discontinuous to the fragmented user data in a destination block together. In this case, the fragmented user data may be stored in the destination block so as to be continuous in the read operation unit of the memory device.

In some example embodiments, when the defragmentation writer 111_2A performs defragmentation in response to that the preset (or, alternatively, desired or determined) condition is satisfied, a fragmentation checker 111_1A may again determine the fragmentation of the user data recorded at the fragmentation information 119_3 of FIG. 14 before the execution of defragmentation.

For example, when the storage device enters the idle state or garbage collection is performed, that is, when the preset (or, alternatively, desired or determined) condition is satisfied, the fragmentation checker 111_1A may again determine the continuity of at least one of a logical address and/or a physical address of at least one of the entries ENT1, ENT2, etc. recorded at the fragmentation information 119_3 of FIG. 14 in the operation unit of the memory device. Accordingly, when fragmentation information is changed after the entries ENT1, ENT2, etc. are recorded at the fragmentation information 119_3, the fragmentation checker 111_1A may change the fragmentation information 119_3. For example, in the case of FIG. 10, when the entries ENT1, ENT2, etc. are recorded at the fragmentation information 119_3, a physical address of the user data whose logical page numbers are 6 (LPN 6) and 10 (LPN 10) may not be continuous to a physical address of the user data whose logical page numbers are 5 (LPN 5) and 7 (LPN 7). After the fragmentation information 119_3 is recorded, due to an operation according to a request of the host device, a physical address of user data with any other logical page number may also be discontinuous. Accordingly, the fragmentation checker 111_1A may again determine the continuity of at least one of a logical address and/or a physical address of at least one of the entries ENT1, ENT2, etc. recorded at the fragmentation information 119_3 in the operation unit of the memory device.

In some example embodiments, the fragmentation information, that is, information of fragmented user data may be recorded as block information, not in the form of a fragmentation list 114_2 of FIG. 14. The block information may include marking information. For example, the marking information may be a flag. For example, when a first block includes discontinuous user data, the block information of the first block may include a flag indicating that discontinuous user data are present in the first block. Alternatively, when the first block includes discontinuous user data, the block information of the first block may include a physical address where the discontinuous user data are stored and a flag corresponding to the physical address. The flag corresponding to the physical address may mean that the discontinuous user data are stored at the physical address.

The block information including the marking information may be block information of a block including user data discontinuous in the operation unit of the memory device. The block information may be meta information including various information of a block of a memory cell array. For example, the block information may include information about a valid page and/or an invalid page of the memory cell array. The block information may be stored in any other region other than a region of the memory cell array, in which user data are stored. For example, the block information may be stored in a preset (or, alternatively, desired or determined) reserved region of the memory cell array.

In some example embodiments, as described above, without performing the defragmentation of user data immediately after the marking information is recorded at the block information, the defragmentation writer 111_2A may perform the defragmentation by referring the block information when the preset (or, alternatively, desired or determined) condition is satisfied. Also, the fragmentation checker 111_1A may again determine the fragmentation of user data recorded at the block information before the execution of defragmentation.

FIG. 15 is a diagram describing a configuration according to some example embodiments of a defragmenter according to some example embodiments of the present disclosure. A defragmenter to be described with reference to FIG. 15 may correspond to the defragmenter 111 of FIGS. 1 and 5. A defragmenter 111B will be described with reference to FIG. 15. Detailed description associated with components the same as or similar to those described above will be omitted to avoid redundancy. The defragmenter 111B will be described based on a difference with the defragmenter 111 described with reference to FIG. 8.

The defragmenter 111B according to some example embodiments of the present disclosure may include a fragmentation checker 111_1B and a defragmentation writer 111_2B.

A sequencer 119_4 may receive the partial write command of first user data from the host device. The partial write command of the first user data may be a partial write command of a first logical address. The sequencer 119_4 may determine the partial write command by referring to the mapping table 119_2. When the received write command is the partial write command, the sequencer 119_4 may transmit a first logical address LPN of the first user data to the fragmentation checker 111_1B.

The first logical address may be one logical address among second logical addresses of second user data stored in the memory device 120 of FIG. 1. The second logical address may be a logical address of the second user data.

The first logical address which is mapped to a first physical address may be already stored in the mapping table 119_2. The second logical addresses which are mapped to second physical addresses may be stored in the mapping table 119_2. The first physical address may be one physical address among the second physical addresses of the second user data stored in the memory device 120.

The second user data may be user data stored in the memory device 120 when the storage device 100 performs the sequential write command. The second user data may be user data stored in the memory device 120 by the execution of the sequential write command of the second logical addresses. For example, the partial write command may refer to the case where after the host device requests to store a large size of user data by using the sequential write command, the host device requests to store partial data revised from among the stored user data.

The sequential write command may refer to the case where the write command for addresses continuous to a data address targeted for the write command is input to the storage device 100 as much as a preset (or, alternatively, desired or determined) reference or more, as described with reference to FIG. 1.

For example, the sequential write command may refer to the case where “m” write commands (m being a preset (or, alternatively, desired or determined) natural number of 2 or more) including a continuous logical address are continuously received from the host device. In this case, even though the storage device 100 continuously receives a plurality of write commands including a continuous logical address, the storage device 100 may receive the write command including any other logical address before receiving “m” read commands continuously. In this case, in some example embodiments, even in the case of receiving the write commands including any other logical address, the number of which is smaller than or equal to “n” (n being a preset (or, alternatively, desired or determined) natural number of 1 or more) determined in advance, the storage device 100 may determine that a continuous condition of the sequential read command is not failed. In addition, the storage device 100 may determine the sequential write command by using various methods, and the present disclosure is not limited to a specific method of determining the sequential write command.

The fragmentation checker 111_1B may determine the probability of fragmentation of the second user data sequentially stored in the memory device 120 in response to receiving the partial write command of the first user data.

By referring the mapping table 119_2, the storage device 100 may determine the continuity of the second logical address and the continuity of the second physical address in the read operation unit of the memory device 120, and the storage device 100 may determine the probability that the second user data sequentially stored in the memory device 120 will be fragmented by the execution of the partial write command.

For example, the first logical address of the first user data requested by the partial write command may be a portion of the second logical address of the second user data previously stored by the sequential write command. In this case, when the storage device 100 performs only the partial write command of the first user in a state where memory cells corresponding to the second logical address including the first logical address are capable of being read through one read operation in the memory device 120, the storage device 100 may determine that the second user data will be fragmented.

The fragmentation checker 111_1B may transmit the fragmentation information FI and/or the first logical address LPN to the defragmentation writer 111_2B as a determination result of the probability of fragmentation. In some example embodiments, the fragmentation checker 111_1B may transmit the second logical address to the defragmentation writer 111_2B.

The defragmentation writer 111_2B may store, as third user data, pieces of user data other than user data stored at the first physical address from among pieces of second user data stored at the second physical address and the first user data of the partial write command at a third physical address. The third physical address may be continuous in the read operation unit of the memory device 120 of FIG. 1.

Accordingly, the memory device 120 may read the third user data stored at the third physical address from the memory cell array 121 of FIG. 1 through one read operation. As a result, the fragmentation of sequentially written user data due to the execution of the partial write command may be prevented or reduced in advance.

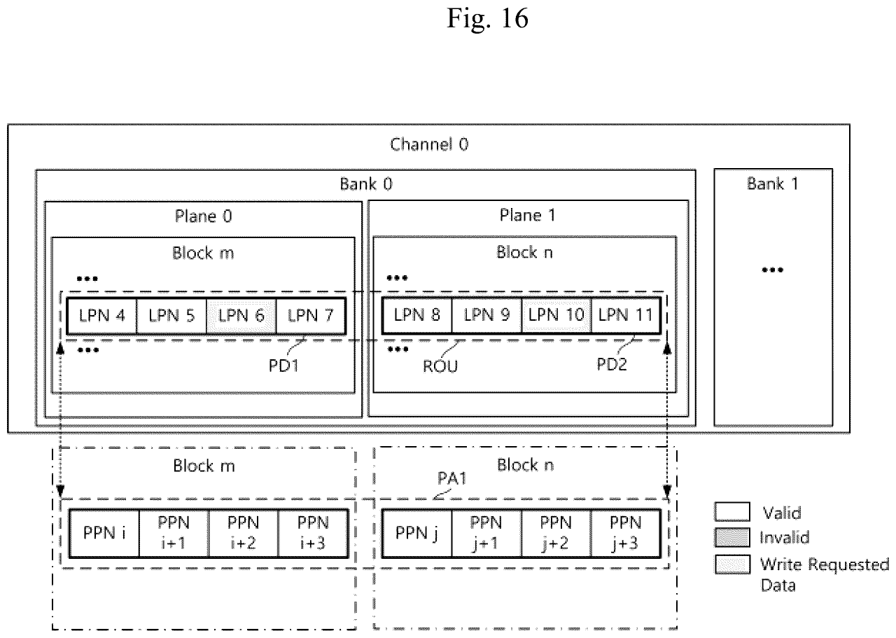

FIG. 16 is a diagram describing the second user data LPN4, . . . , LPN 11 sequentially written before the defragmenter 111B according to some example embodiments performs defragmentation.

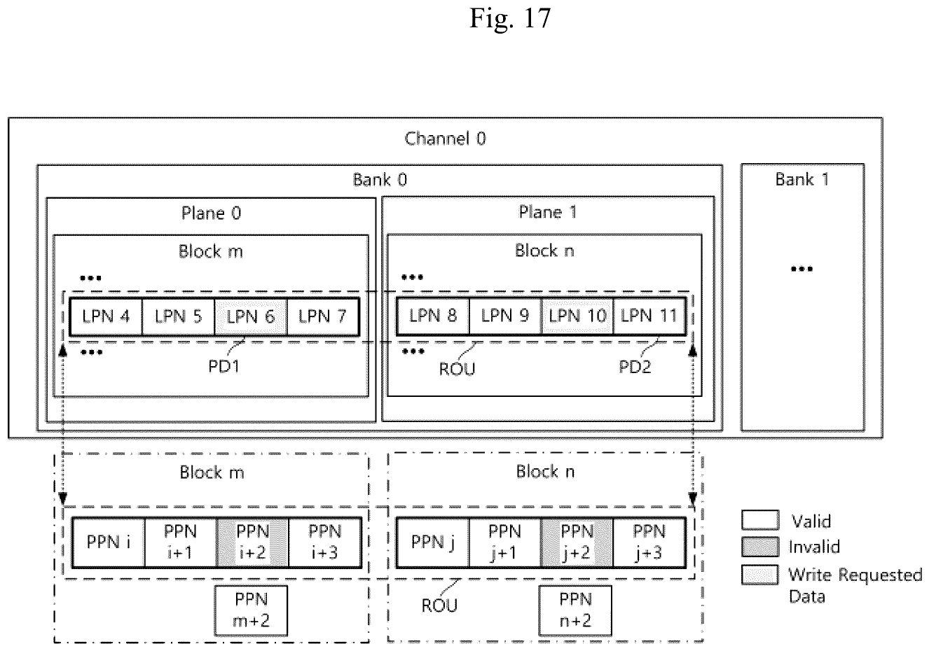

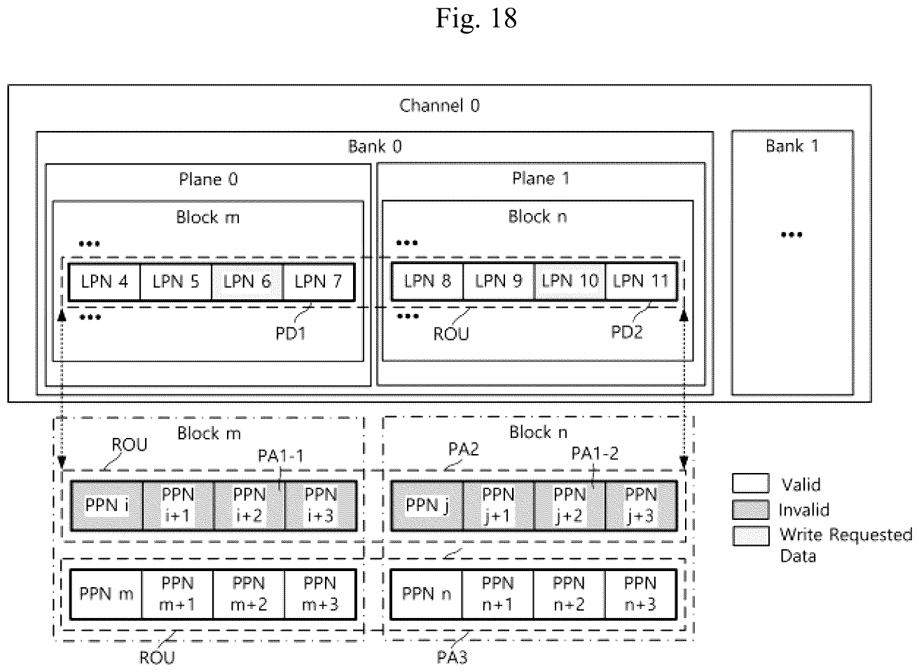

FIG. 17 is a diagram describing user data after a defragmenter according to some example embodiments performs a partial write command, and FIG. 18 is a diagram describing user data after the defragmenter 111B according to some example embodiments performs defragmentation in response to a partial write command.

Referring to FIG. 16, the second user data LPN4, . . . , LPN 11 may be continuously stored in an m-th block of a 0-th plane of a 0-th bank of a 0-th channel of a memory device and a n-th block of a first plane of the same 0-th bank in the read operation unit ROU, so as to be read through one read operation. That is, the second user data LPN4, . . . , LPN 11 may be stored at physical addresses PPN i, . . . , PPN i+3 of the m-th block of the 0-th plane of a memory cell array and physical addresses PPN j, . . . , PPN j+3 of the n-th block of the first plane. For convenience of description, in some example embodiments, the second user data LPN4, . . . , LPN 11 stored at different planes may be referred to as “(2-1)-th user data PD1 (LPN 4, . . . , LPN7)” and “(2-2)-th user data PD2 (LPN 8, . . . , LPN 11)”. The memory device may read the user data of the physical addresses PPN i, . . . , PPN i+3 of the m-th block of the 0-th plane and the physical addresses PPN j, . . . , PPN j+3 of the n-th block of the first plane through one read operation.

Referring to FIG. 16, the storage device 100 of FIG. 1 may receive the partial write command of the first user data whose logical page number is 6 (LPN 6) and/or the first user data whose logical page number is 10 (LPN 10) from the host device.

Referring to FIG. 17, the defragmenter according to some example embodiments may perform the partial write command of the first user data whose logical page number is 6 (LPN 6) and/or the first user data whose logical page number is 10 (LPN 10) from the host device. That is, the defragmenter may store the first user data LPN 6 stored at the physical address PPN i+2 at a physical address PPN m+2 and/or may store the first user data LPN 10 stored at the physical address PPN j+2 at a physical address PPN n+2.

As a result, even though the logical addresses of the second user data LPN4, . . . , LPN 11 are continuous, because a physical address is not continuous in the read operation unit ROU of the memory device, it may be impossible to read the second user data LPN4, . . . , LPN 11 through one read operation.

Referring to FIG. 18, when the defragmenter 111B according to some example embodiments of the present disclosure performs the partial write command of the first user data whose logical page number 6 (LPN 6) and/or the first user data whose logical page number is 10 (LPN 10), the defragmenter 111B may determine that the second user data LPN4, . . . , LPN 11 will be fragmented and may perform the partial write command together with the defragmentation. Because the first logical address of the first user data LPN 6 and LPN 10 targeted for the partial write command is a part of the second logical addresses of the second user data LPN4, . . . , LPN 11 sequentially written, the defragmenter 111B may perform the partial write command together with the defragmentation.

For example, referring to FIG. 18, the defragmenter 111B may read the second user data LPN4, LPN 5, LPN 7, LPN 8, LPN 9, and LPN 11 among the second user data LPN4, . . . , LPN 11 other than the user data of the physical address PPN i+2 and PPN j+2 mapped to the first logical address of the first user data LPN 6 and LPN 10 of the partial write command from the physical address PPN i, PPN i+1, PPN i+3, PPN j, PPN j+1, and PPN j+3 and may store the second user data LPN4, LPN 5, LPN 7, LPN 8, LPN 9, and LPN 11 at a third physical address PPN m, . . . , PPN m+3 and PPN n, . . . , PPN n+3 (collectively referred to as “PA3”) together with the first user data LPN 6 and LPN 10 of the partial write command. The third physical address PA3 (PPN m, . . . , PPN m+3 and PPN n, . . . , PPN n+3) may be continuous in the read operation unit ROU of the memory device 120. That is, the memory device 120 may read the user data of the third physical address PA3 (PPN m, . . . , PPN m+3 and PPN n, . . . , PPN n+3) through one read operation. The storage device 100 may record the second physical address PPN i, . . . , PPN i+3 and PPN j, . . . , PPN j+3 as being invalid.

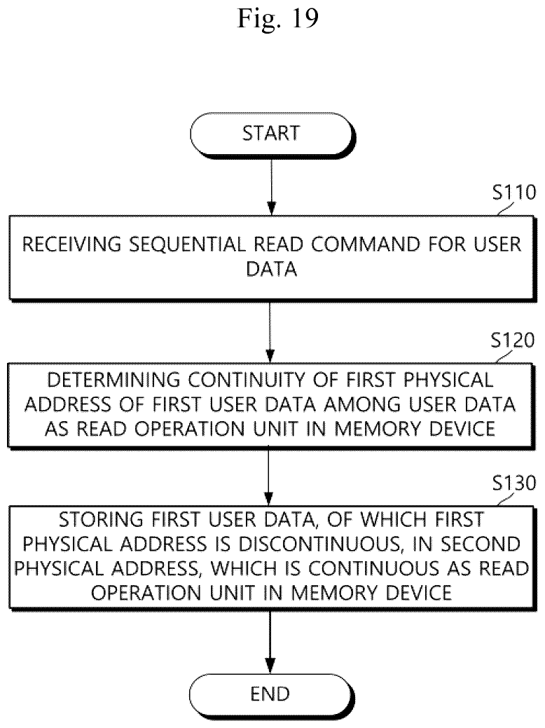

FIG. 19 is a diagram describing an operating method of a storage device according to some example embodiments of the present disclosure. The method of FIG. 19 may be performed by the storage device 100 of FIG. 1.

Description which is the same as or similar to that given with reference to FIGS. 1 to 18 will be omitted to avoid redundancy.

Referring to FIG. 19, in operation S110, the memory controller 110 of FIG. 1 may receive the sequential read command for user data from the host device.

In operation S120, the memory controller 110 may determine the continuity of a physical address of at least some among pieces of sequential read-requested user data in the read operation unit of the memory device.

For example, as described with reference to FIGS. 9 and 10, the memory controller 110 may determine the continuity of a physical address of user data based on whether the memory device 120 of FIG. 1 is capable of reading the user data through one read operation.

In operation S130, the memory controller 110 may store first user data, the first physical address of which is discontinuous, from among the pieces of sequential read-requested user data at a second physical address continuous in the read operation unit of the memory device 120.

For example, the memory controller 110 may store the first user data PD1, PD2, PD3, and PD4, which are discontinuous in the read operation unit ROU of the memory device 120 like the embodiment of FIG. 10, at the second physical address PA2 continuous in the read operation unit ROU of the memory device 120 like the embodiment of FIG. 11.

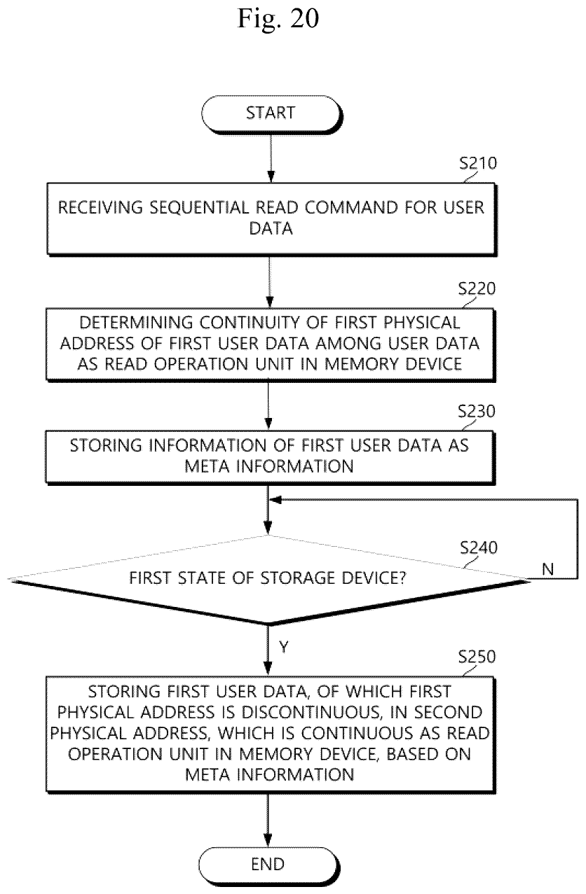

FIG. 20 is a diagram describing an operating method of a storage device according to embodiment of the present disclosure. The method of FIG. 20 may be performed by the storage device 100 of FIG. 1.

Description which is the same as or similar to that given with reference to FIGS. 1 to 19 will be omitted to avoid redundancy.

Referring to FIG. 20, operation S210 and operation S220 may be the same as operation S110 and operation S120 described with reference to FIG. 19, respectively.

In operation S230, the memory controller 110 may store information of first user data whose physical address is discontinuous from among the pieces of sequential read-requested user data as meta information. For example, the memory controller 110 may store at least one of the first logical address and the first physical address of the first user data as a fragmentation list described with reference to FIG. 14. Alternatively, the memory controller 110 may record information of pieces of fragmented user data at block information. The block information may be meta information including various information of a block of a memory cell array.

In operation S240, the memory controller 110 may determine whether the preset (or, alternatively, desired or determined) condition is satisfied.

In some example embodiments, the preset (or, alternatively, desired or determined) condition may be satisfied when it is determined that a storage device enters an idle state or when it is determined that garbage collection should be performed.

When the preset (or, alternatively, desired or determined) condition is satisfied, in operation S250, the memory controller 110 may perform the defragmentation of the first user data by referring to meta information in which information of the first user data whose physical address is discontinuous is recorded. Operation S250 may be similar to operation S130 described with reference to FIG. 19.

In some example embodiments, when the preset (or, alternatively, desired or determined) condition is satisfied, the memory controller 110 may again determine the fragmentation of the first user data recorded at the meta information in the read operation unit of the memory device, before the execution of the defragmentation. When the fragmentation information of the first user data is different from the meta information, the memory controller 110 may change the meta information.

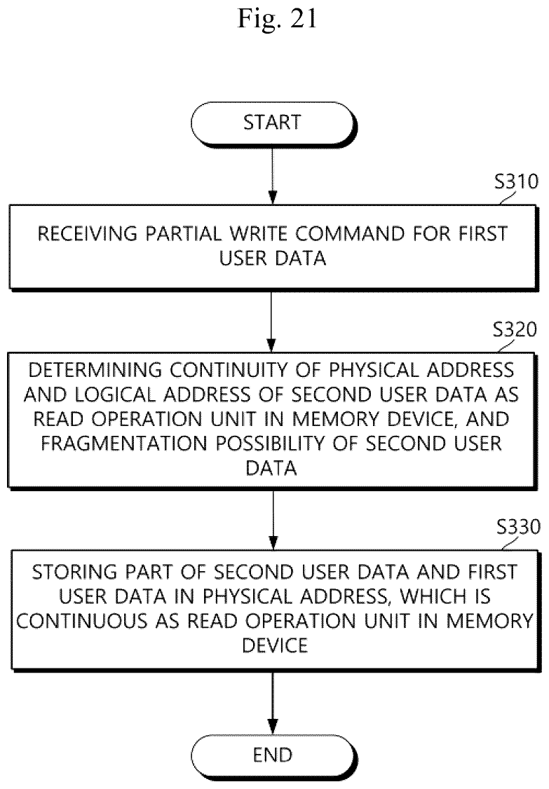

FIG. 21 is a diagram describing an operating method of a storage device according to embodiment of the present disclosure. The method of FIG. 21 may be performed by the storage device 100 of FIG. 1.

Description which is the same as or similar to that given with reference to FIGS. 1 to 20 will be omitted to avoid redundancy.

Referring to FIG. 21, in operation S310, the memory controller 110 of FIG. 1 may receive the partial write command for the first user data from the host device. The partial write command may be a command requesting to store the first user data at the first logical address. The first logical address may be already stored in a mapping table as corresponding to the first physical address.

In operation S320, in response to the partial write command for the first user data, the memory controller 110 may determine the continuity of a second physical address of second user data and the continuity of a second logical address of the second user data in the read operation unit of the memory device. The first logical address of the first user data may be a logical address included in second logical addresses. When the second logical address and the second physical address are continuous in the read operation unit of the memory device, the memory controller 110 may determine that the second user data will be fragmented by the execution of the partial write command for the first user data.

For example, the first logical address of the first user data requested by the partial write command may be a part of the second logical address of the second user data previously stored by the sequential write command. In this case, when the storage device 100 performs only the partial write command of the first user in a state where memory cells corresponding to the second logical address including the first logical address are capable of being read through one read operation in the memory device 120, the storage device 100 may determine that the second user data will be fragmented.

In operation S330, the memory controller 110 may store some of the first user data and the second user data at a third physical address. The third physical address may be continuous in the read operation unit of the memory device. Some of the second user data may be pieces of user data other than pieces of user data stored at the first physical address from among the pieces of second user data stored at the second physical address.

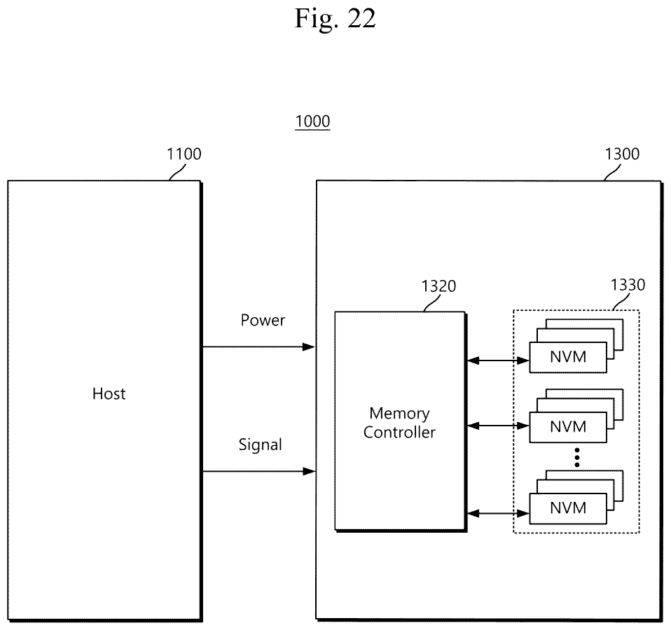

FIG. 22 is a block diagram showing a storage system according to some example embodiments.

Referring to FIG. 22, the storage system 1000 may include a host 1100 and a storage device 1300. The storage device 1300 transmits and receives signals with the host 1100 through a signal connector, and receives a power through a power connector. The storage device 1300 may include a memory controller 1320, and a memory device 1330 including memory devices 1331, 1332, . . . , 133n. The memory devices 1331, 1332, . . . , 133n may be NAND flash memory devices, however, example embodiments are not limited thereto. According to some example embodiments, the memory controller 1320 may be the same as or similar to the memory controller 110 of FIGS. 1 and 4 or as otherwise mentioned in the specification, and the memory device 1330 may be the same as or similar to the memory device 120 of FIGS. 1, 4, and 6 or as otherwise mentioned in the specification. According to some example embodiments, the host 1100 may be the same as or similar to the host as mentioned elsewhere in the specification.

A storage device according to the present disclosure may perform more efficient or improved defragmentation of fragmented user data. Accordingly, the quality of service of the storage device may be improved, e.g., by more reliable data accessing, faster data sharing, and/or improved power consumption and use of computing resources.

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

While the present disclosure has been described with reference to example embodiments thereof, it will be apparent to those of ordinary skill in the art that various changes and modifications may be made thereto without departing from the spirit and scope of the present disclosure as set forth in the following claims.

What is claimed is:

1. A storage device comprising:
a memory device including a plurality of nonvolatile memory blocks; and
a memory controller configured to control the memory device,
wherein the memory controller is configured to:
determine continuity of a first physical address of first user data among user data stored in the memory device in a read operation unit of the memory device in response to a sequential read command for the user data; and
store the first user data whose first physical address is discontinuous at a second physical address continuous in the read operation unit of the memory device.

2. The storage device of claim 1, wherein the memory controller determines that there is no continuity of the first physical address based on a first logical address of the first user data being continuous and it being impossible to read the first user data through one read operation in the memory device.

3. The storage device of claim 1, wherein the first user data stored at the second physical address are capable of being read by one read operation in the memory device.

4. The storage device of claim 3, wherein the first user data stored at the second physical address are stored in a plurality of memory blocks of different planes of the same bank in the memory device.

5. The storage device of claim 1, wherein
a size of the read operation unit of the memory device is a first data size, and
the memory controller is configured to determine the continuity of the first physical address of the first user data corresponding to the first data size in the read operation unit of the memory device.

6. The storage device of claim 5, wherein
the memory controller is configured to store the first user data at the second physical address based on a first logical address of the first user data being continuous and the first physical address of the first user data being discontinuous in the read operation unit of the memory device, and
the second physical address includes a plurality of physical addresses continuous to each other in the read operation unit of the memory device.

7. The storage device of claim 1, wherein
the memory device includes a plurality of memory cells,
the memory device is configured to sense a first number of memory cells through one read operation in response to one internal read command received from the memory controller, and
a size of the first user data stored at the second physical address correspond to the first number of memory cells.

8. The storage device of claim 1, wherein the memory controller is configured to store at least one of a first logical address and the first physical address of the first user data, the first physical address of which is discontinuous in the read operation unit of the memory device, as a list.

9. The storage device of claim 8, wherein, before the first user data are stored at the second physical address, the memory controller is configured to again determine at least one of continuity of the first logical address and the continuity of the first physical address and changes the list.

10. The storage device of claim 1, wherein
the memory controller is configured to store marking information indicating discontinuity, in block information corresponding to the first user data, the first physical address of which is discontinuous in the read operation unit of the memory device, and
the block information includes information about a valid page.

11. The storage device of claim 10, wherein the memory controller is configured to store the first user data at the second physical address continuous in the read operation unit of the memory device, together with execution of garbage collection.

12. The storage device of claim 1, wherein the memory controller is configured to store the first user data at the second physical address continuous in the read operation unit of the memory device at an idle time.

13. The storage device of claim 1, wherein the memory controller is configured to:
store the first user data at the second physical address continuous in the read operation unit of the memory device in response to a condition; and
again determine at least one of continuity of a first logical address of the first user data and the continuity of the first physical address in a read operation unit of the memory device, before the first user data are stored at the second physical address.

14. A storage device comprising:
a memory device including a plurality of nonvolatile memory blocks; and
a memory controller configured to control the memory device,
wherein the memory controller is configured to:
receive a write command including a first logical address and first user data;
determine continuity of a second logical address of second user data and continuity of a second physical address of the second user data in a read operation unit of the memory device; and
based on the second logical address and the second physical address being continuous, store pieces of user data other than user data stored at a first physical address from among pieces of second user data stored at the second physical address and the first user data as a third physical address as third data,
wherein the third physical address is continuous in the read operation unit of the memory device,
wherein the first logical address is included in the second logical address, and
wherein the first logical address is mapped to the first physical address.

15. The storage device of claim 14, wherein the third user data are capable of being read by one read operation in the memory device.

16. An operating method of a storage device, the method comprising:
data;
determining, at the memory controller, continuity of a first physical address of first user data among the user data stored in a memory device in a read operation unit of the memory device; and
storing, at the memory controller, the first user data, the first physical address of which is discontinuous, at a second physical address continuous in the read operation unit of the memory device.

17. The operating method of claim 16, further comprising:
storing, at the memory controller, information of the first user data, the first physical address of which is discontinuous in the read operation unit of the memory device, as a list,
wherein the information includes at least one of a first logical address and the first physical address of the first user data.

18. The operating method of claim 16, further comprising:
storing, at the memory controller, information of the first user data, the first physical address of which is discontinuous, as meta information; and
before the first user data are stored at the second physical address, again determining, at the memory controller, the continuity of the first physical address of the first user data in the read operation unit of the memory device, based on the meta information.

19. The operating method of claim 17, wherein
the memory controller stores the first user data at the second physical address in a first state, and
the first state is a state where garbage collection is performed or an idle state where there is no execution of an input/output request from a host device.

20. The operating method of claim 16, further comprising:
determining that there is no continuity of the first physical address, based on a first logical address of the first user data being continuous and it being impossible to read the first user data through one read operation in the memory device.
